(19) United States
(12) Patent Application Publication
(10) Pub. No.: US 2009/0224677 A1
(43) Pub. Date: Sep. 10, 2009

(54) Ion generating light assembly

(76) Inventor: William Kinsey, Valencia, CA (US)

Correspondence Address: CHARLES R. SUTTON,;LAW OFFICES OF ROGER C. HSU, 201 S. LAKE AVE., STE.,600, PASADENA, CA, 91101, US

(21) Appl. No.: 12/074,665

(22) Filed: Mar. 4, 2008

(51) Int. Cl. H05B 37/02

(52) U.S. Cl. 315/149

(57) ABSTRACT

A light to screw into a standard light socket having a negative ion generator in the form of a pin. The pin design can be easily cleaned with a swab and cleaning solution such as rubbing alcohol, eliminating the need to trim or clean a brush electrode when corrosion or deposits form. The negative ion generator produces the negative ions to purify the air. The device can have a light sensor to activate the light when light is low. The device can also come with light emitting diodes which can be set to indicate the status of the various systems of the device. The device can come equipped with an air freshener that disperses vaporized perfume into the air.

### CROSS REFERENCE TO RELATED APPLICATIONS

There are no related applications.

### STATEMENT REGARDING FEDERALLY SPONSORED RESEARCH OR DEVELOPMENT

This invention was not made using federally sponsored research and development. The inventor retains all rights.

### BACKGROUND OF THE INVENTION

There are numerous inventions generating negative ions for one purpose or another, many of which claim both a positive and a negative pole or have a brush shaped ion generator. Excessively complex generators can greatly reduce life span of the device because, frankly, difficulties in cleaning generally result in no cleaning. Cleaning techniques involving the trimming of brush filaments will obviously result in reduction of the brush filament surface area available. Eventually the ion generating surface is either so oxidized or corroded that the number of ions emitted is substantially reduced or else the ion generating surface is reduced to nothing by the act of trimming. Either way a new device becomes necessary. Frequently generating negative ions is for the purpose of cleaning the air. Other devices exist which provide fragrances for the air, thus masking disagreeable odors. Sometimes these fragrance distributors are combined with a plug in night light. These devices do not actually clean the air of underlying odor causing agents. They simply add other chemicals into the air. Other devices exist which feature a night light that can be automatically activated in the event there is no illumination. The light is switched on automatically at night. Negative ions have been proven to remove the following particles from the air, resulting in healthier living conditions and reduction of odors: animal dander, toxic chemicals, bacteria, dust mites, dead skin, smoke, pollen, dust, insect feces, and mold spores. Negative ions in the air can vitalize the human body as though one is in a forest, near a waterfall, or near a hot spring. Inhaled, negative ions accelerate the metabolism, promote vitality, enhance blood flow, stabilize the nervous system, and help fight fatigue. They also increase alertness, reduce asthma and allergy symptoms, and improve sleep.

### BRIEF SUMMARY OF THE INVENTION

A light to screw into a standard light socket having a negative ion generator in the form of a pin. The pin design can be easily cleaned with a swab and cleaning solution such as rubbing alcohol, eliminating the need to trim or clean a brush electrode when corrosion or deposits form. The pin does not become oxidized as fast as the typical brush style electrode. This represents an improvement over prior art devices which present cleaning difficulties that result in limited useful life span of the device. In one embodiment the negative ion generator is always on while the device is plugged into a socket and produces the negative ions to purify the air. The device has a light and can have a light sensor to activate the light when light is low. The device can also come with light emitting diodes which can be set to indicate the status of the various systems of the device. The device can come equipped with an air freshener that disperses vaporized perfume into the air. Referring now to FIG. 1, in the preferred embodiment the device has a base (1), a threaded plug (2) which is adapted to be fitted into a standard light socket, a self ballast florescent light (3), and an ion generator (4) in the form of an easily cleanable pin. The ions are dispersed into the air where they attach themselves to numerous unwanted particles such as bacteria and dust, and remove those particles from the air.

### BRIEF DESCRIPTION OF THE SEVERAL VIEWS OF THE DRAWINGS

FIG. 1 shows the invention with its pin electrode, lamp, screw adapter and base.

FIG. 2 shows a circuit diagram for a 13 watt version of the invention

FIG. 3 shows a printed circuit board routing diagram for a 13 watt embodiment

FIG. 4 shows another printed circuit routing diagram for a 13 watt embodiment

FIG. 5 shows a perspective view of the invention

FIG. 6 shows a circuit diagram for a 23 watt version of the invention

FIG. 7 shows a printed circuit board routing diagram for a 23 watt embodiment

FIG. 8 shows another printed circuit routing diagram for a 23 watt embodiment

FIG. 9 shows a perspective view of the invention

FIG. 10 shows a circuit diagram for a 5 watt version of the invention

FIG. 11 shows a printed circuit board routing diagram for a 5 watt embodiment

FIG. 12 shows another printed circuit routing diagram for a 5 watt embodiment

FIG. 13 shows a perspective view of the invention

### DETAILED DESCRIPTION OF THE INVENTION

A light to screw into a standard light socket having a negative ion generator in the form of a pin. The pin design can be easily cleaned with a swab and cleaning solution such as rubbing alcohol, eliminating the need to trim or clean a brush electrode when corrosion or deposits form. This represents an improvement over prior art devices which present cleaning difficulties that result in limited useful life span of the device. In one embodiment the negative ion generator is always on when the device is in a socket and produces the negative ions to purify the air. The device has a light and can have a light sensor to activate the light when light is low. The device can also come with light emitting diodes which can be set to indicate the status of the various systems of the device. The device can come equipped with an air freshener that disperses vaporized perfume into the air. It has an energy saving light mounted in a socket, a control circuit connected to the socket, a negative ion generator in the form of an easily cleanable pin, and a voltage amplification circuit that outputs to the negative ion generating pin. The ions that are generated are negative. They result in a breaking down of the ions in the air either to positive or negative. The negative ions that are generated by the device are convected and cause a binding of the heavier positive ions (which are undesirable) so that they fall to the floor or are deposited on the pin. These positive ions are undesirable because they are unhealthful and/or cause odor. In the preferred embodiment, the aperture between the coils of the light tube is large enough to admit a swab so the pin can be easily cleaned with a swab using a solution perhaps containing alcohol.

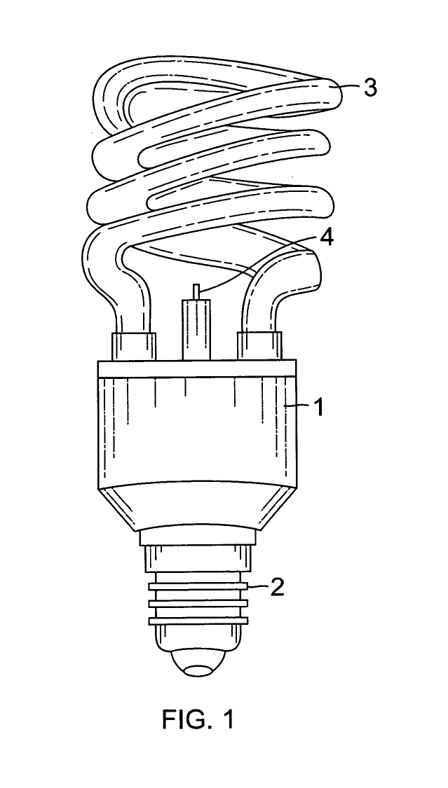

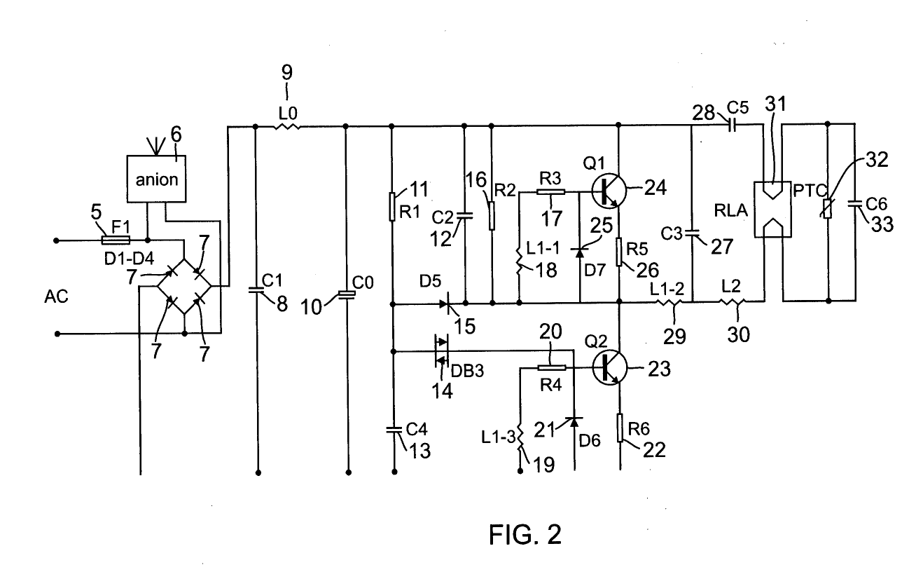

Referring now to FIG. 1, in the preferred embodiment the device has a base (1), a threaded plug (2) which is adapted to be fitted into a standard light socket, a self ballast florescent light (3), and an ion generator (4) in the form of an easily cleanable pin. Turning now to FIG. 2, there is an F1 (5), an anion (6), D1-D4 (7), a C1 (8), an L0 (9), a C0 (10), an R1 (I1), a C2 (12), a C4 (13), a DB3 (14), a D5 (15), an R2 (16), an R3 (17), an L1-1 (18), an L1-3 (19), an R4 (20), a D6 (21), an R6 (22), a Q2 (23), a Q1 (24), a D7 (25), an R5 (26), a C3 (27), a C5 (28), an L1-2 (29), an L2 (30), an RLA (31), a PTC (32), and a C6 (33) as well as AC.

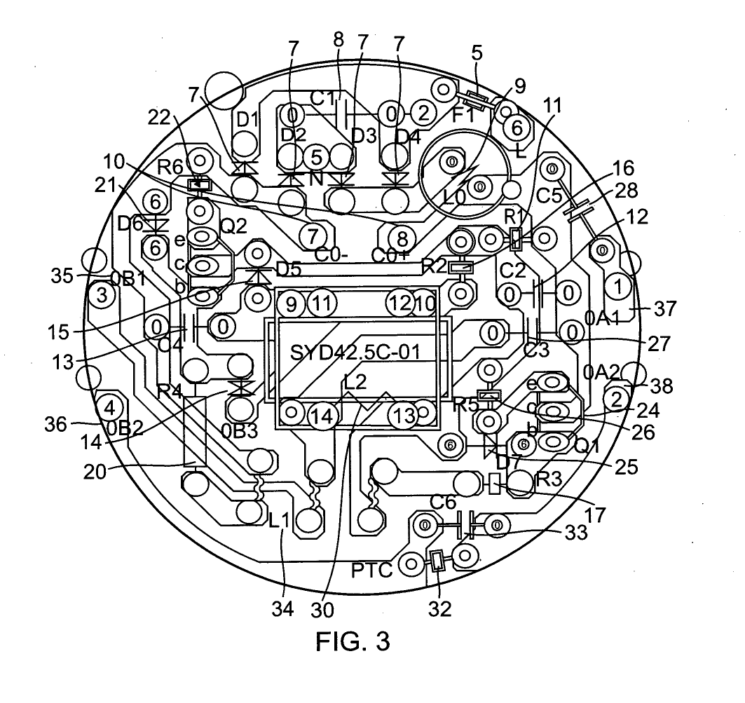

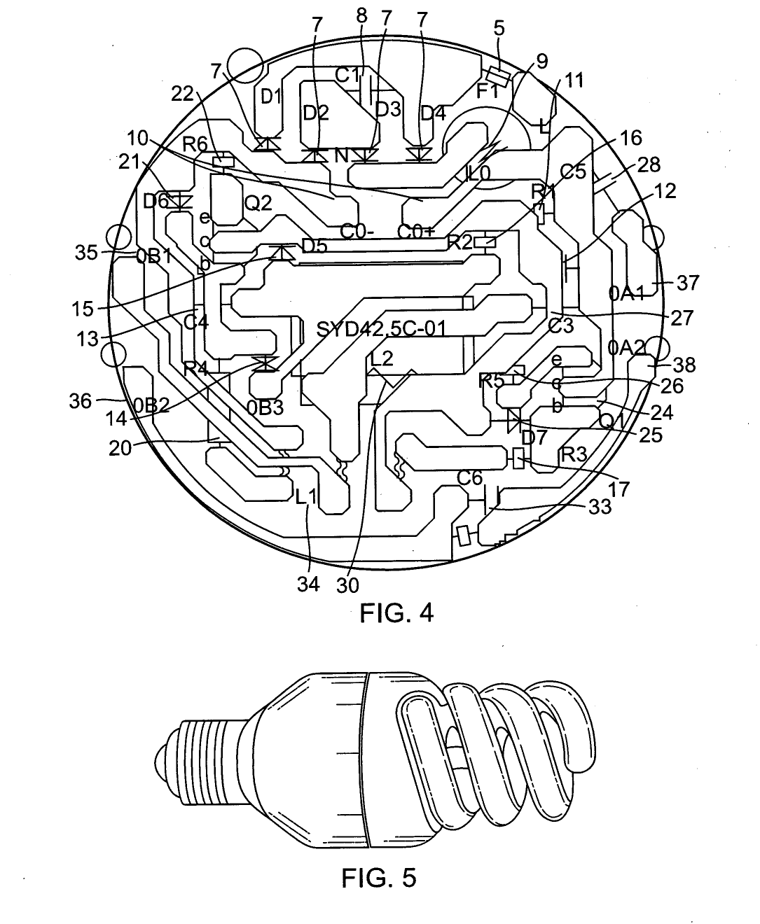

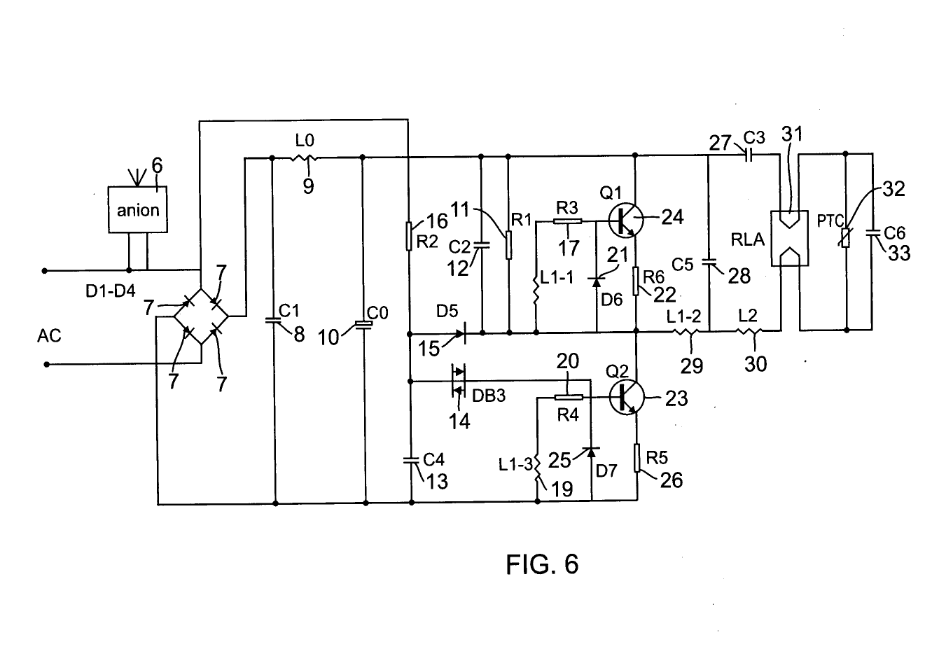

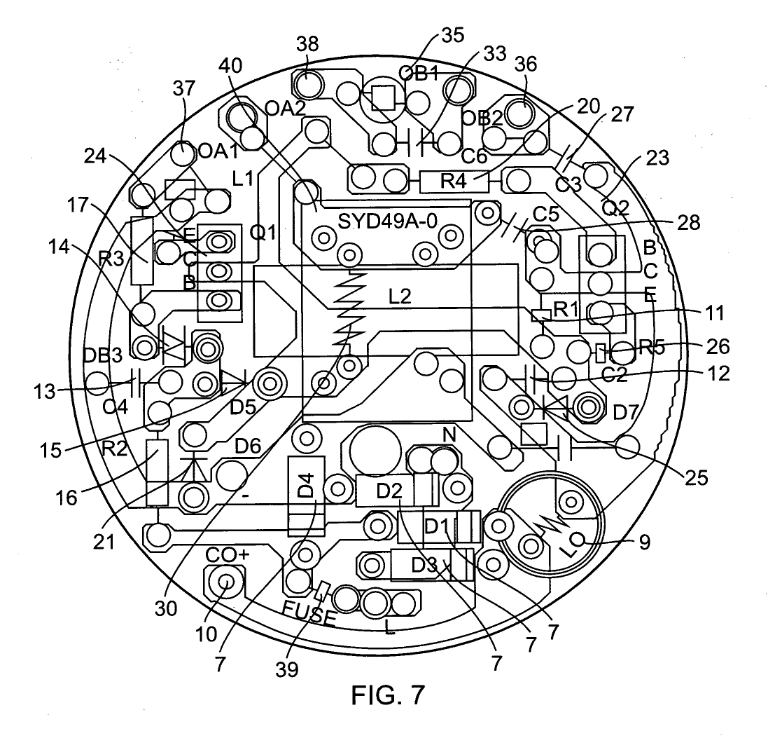

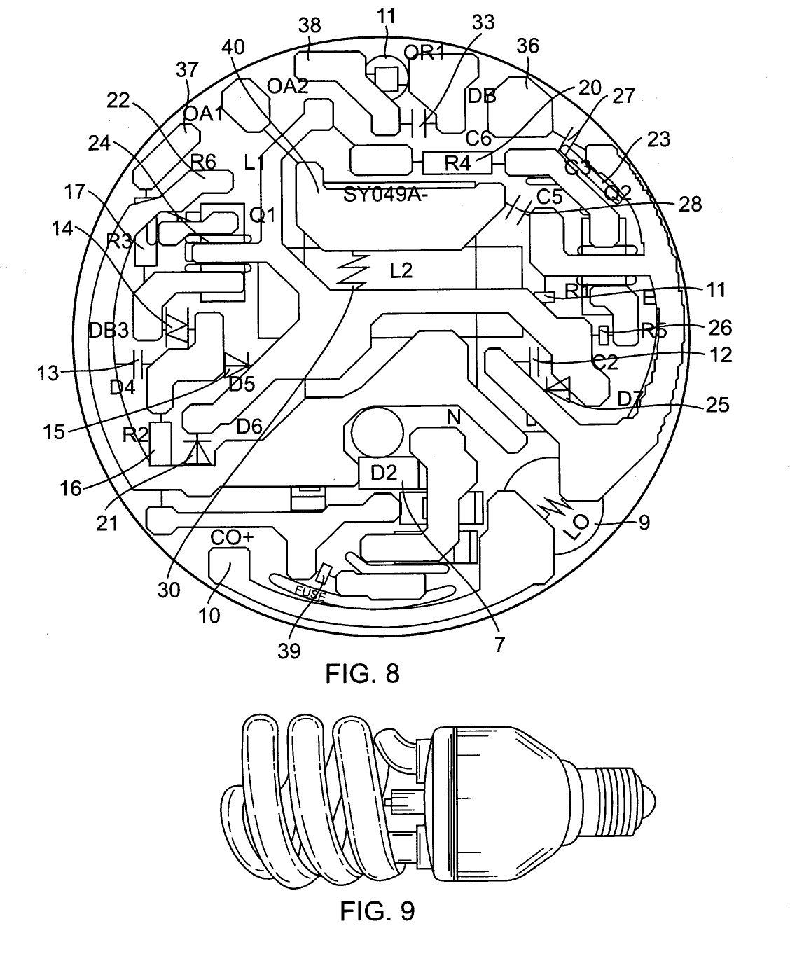

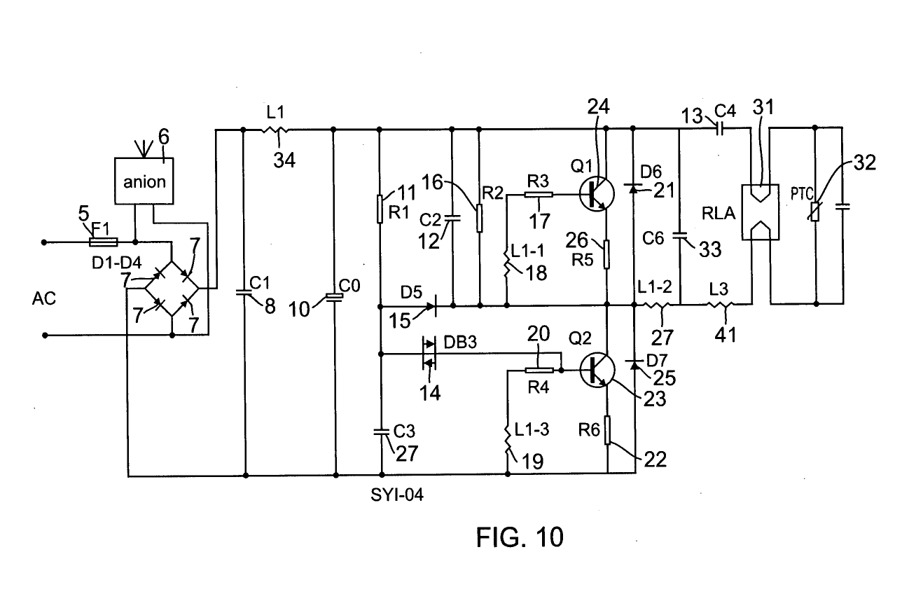

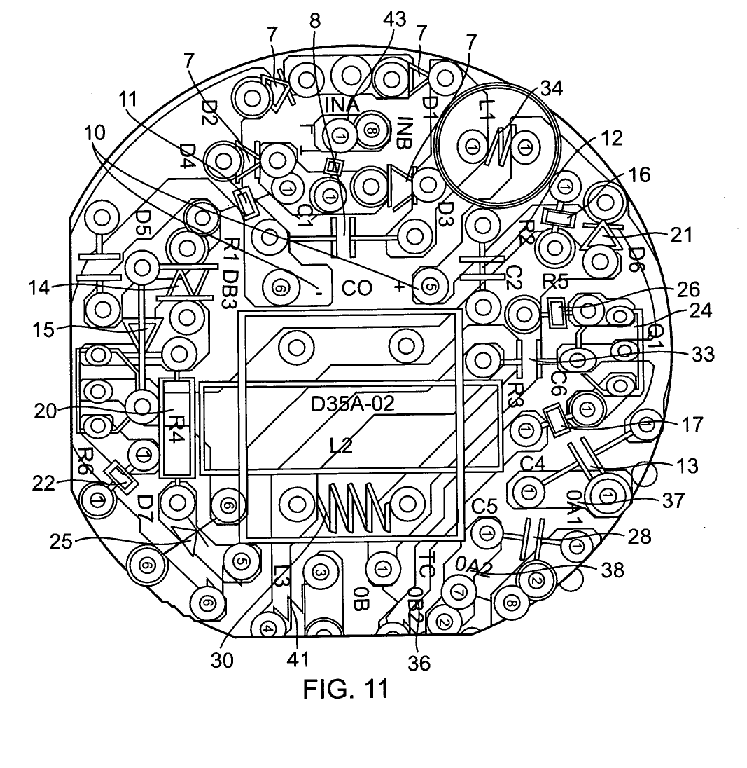

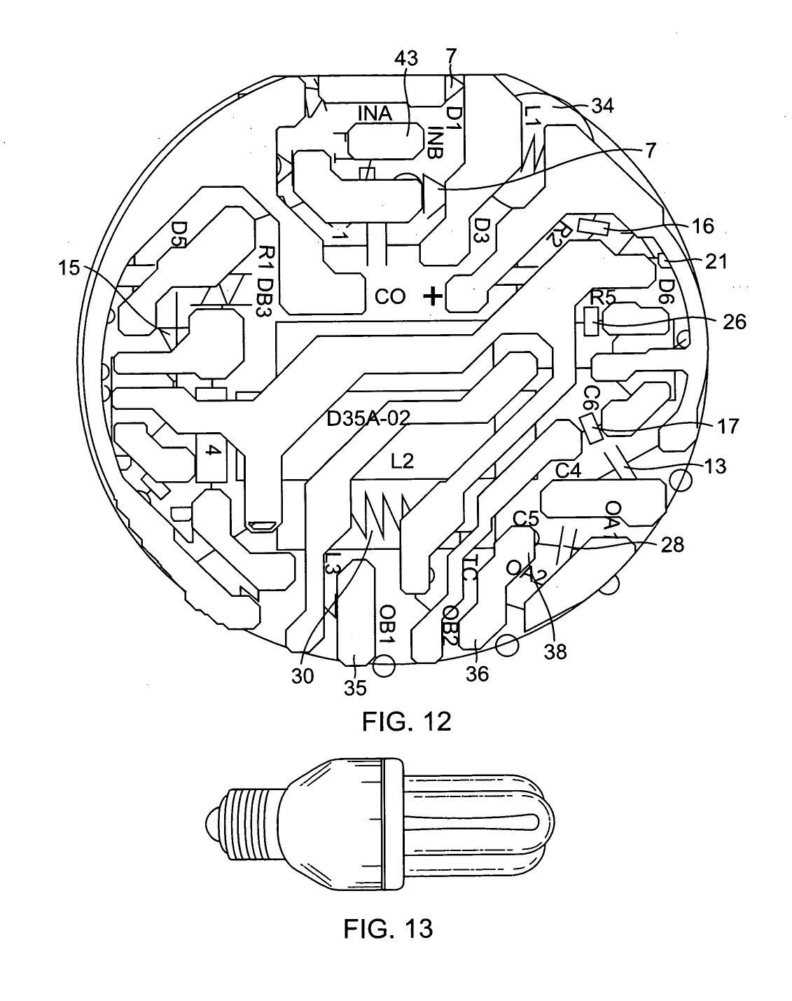

Turning now to FIG. 3, there is an L1 (34), an OB1 (35), an OB2 (36), an OA1 (37), and an OA2 (38). Turning now to FIG. 7, there is a fuse (39), and an SYD49A-0 (40). Turning now to FIG. 10, there is an L3 (41). Turning now to FIG. 11, there is a D35A-02 (42) and an INA/INB (43).

I claim:

1. An ion generating light assembly comprising:
a plug adapted to fit into a standard light socket; said plug being operatively connected to a control circuit, a voltage amplification circuit, a light and an ion generator; said ion generator having a pin to produce ions.

2. The ion generating light assembly of claim 1 in which said light is a self ballasted florescent light.

3. The ion generating light assembly of claim 1 having a switch.

4. The ion generating light assembly of claim 3 in which said light is a self ballasted florescent light.

5. The ion generating light assembly of claim 1 having a light sensor.

6. The ion generating light assembly of claim 5 in which said light is a self ballasted florescent light.

7. The ion generating light assembly of claim 5 further comprising means to vaporize chemicals having a pleasant scent and distribute said chemicals outside said ion generating light assembly.

8. The ion generating light assembly of claim 7 further comprising means to vaporize chemicals having a pleasant scent and distribute said chemicals outside said assembly.

9. The ion generating light assembly of claim 5 further comprising light emitting diodes visible from outside said ion generating light assembly; said light emitting diodes being connected to said control circuit; and said light emitting diodes providing information about the status of said control circuit.

10. The ion generating light assembly of claim 9 in which said light is a self ballasted florescent light.

11. The ion generating light assembly of claim 1 having a light sensor connected to said control circuit and adapted to activate said light in the event of low ambient light conditions.

8. The ion generating light assembly of claim 11 in which said light is a self ballasted florescent light.
